(19) United States
(12) Patent Application Publication
(10) Pub. No.: US 2012/0278876 A1
(43) Pub. Date: Nov. 1, 2012

(54) SYSTEM, METHOD AND BUSINESS MODEL FOR AN IDENTITY/CREDENTIAL SERVICE PROVIDER

(76) Inventor: GREG MCDONALD, Orleans (CA)

(21) Appl. No.: 13/096,118

(22) Filed: Apr. 28, 2011

(51) Int. Cl. H04L 9/32

(52) U.S. Cl. 726/9; 726/5

(57) ABSTRACT

A methodology, system and business model are disclosed for facilitating a fully automated electronic identity service between a group of consumers and a group of service providers. The system includes at least one servicer and associated computers and memories. A security token is issued to the consumer by an authority. The consumer then personalizes the token by having his or her civil credentials loaded onto the card. The card is serialized by the authority. When the consumer desires access to a service, the system with authenticate the identity of the consumer. Various levels of authentication can be achieved. The service providers will subscribe to system.

### CROSS-REFERENCE TO RELATED APPLICATIONS

This application claims the benefit under 35 USC 120 of U.S. Provisional Patent Application No. 61/326,837 on Apr. 22, 2010.

### FEDERAL FUNDING

N/A

### FIELD OF THE INVENTION

This invention relates to identity based credential assurance using privacy compliant, non-reputable electronic human authentication and specifically to a system, method and business model for an identity/credential service provider.

### BACKGROUND

Thousands of situations require a person's identity to be established. For example, before access is granted to an individual's taxation information stored on a government server, identity needs to be established; before funds can be withdrawn from a bank, identity is established; before a medical provider accesses a patient's electronic health record, identity is established; before a book can be checked out of the library identity is established; and, finally, before an individual starts work for an employer or enrolls in college, identity is established.

Significant problems still exist with respect to security of the Internet, personal identity, electronic data and e-commerce. The following examples are illustrative:
“Protecting the public Internet . . . is a vital part of protecting America's national security,” says Mike McCurry, co-chair of Arts+Labs, a lobbying group formed last September by Viacom, NBC Universal, AT&T, Microsoft, Cisco and the Songwriters Guild of America. “Cybercrime cost businesses an estimated $1 trillion worldwide in 2008,” continued McCurry¹. ¹Cyber Security Compromised:
The 2009 KPMG eCrime Survey² reports that user passwords, PKI credentials, one-time-password tokens, and smart cards do not adequately protect sensitive data from sophisticated hackers and organized crime. ²KPMG 2009 e-Crimes Survey:
In the US the number of identity theft victims rose 22% to a record 9.9 million in 2008 from 8.1 million a year earlier, with fraud losses increasing to $45 billion according to the fifth annual study by Javelin Strategy & Research³. ³Identity Theft Statistics from Javelin:
Another recent US study shows a significant increase in identity fraud in 2009, highlights the need for greater consumer awareness when it comes to avoiding scams and identity theft. According to the Javelin Strategy & Research 2010 Identity Fraud Survey Report, the number of identity fraud victims in the United States jumped in 2009 by 12 percent from the previous year to 11.1 million adults—the highest increase since the survey was first conducted in 2003. The survey also found an increase in computer-based crimes, indicating that thieves are increasingly taking advantage of online channels.
One in every 6 adults and one in every 5 households has been the victim of identity theft according to the US Federal Trade Commission. Individual Americans lost more than $5 billion and businesses lost approximately $47.5 billion due to this epidemic.
A 2009 Consumer Survey by McMaster⁴ University reported that “6.5% of Canadian adults, or almost 1.7 million people were the victims of some kind of identity theft in the last year.”⁴Source: Measuring Identity Theft in Canada: 2008 Consumer Survey—Working Paper #23, McMaster eBusiness Research Centre:
Approximately 41 million US citizens and 1.5 million Canadians pay on average $15 per month for “after the fact” Identity Theft Protection Services.
The “2009 Report on Organized Crime in Canada⁵” released on Aug. 7, 2009, by the Criminal Intelligence Service Canada (CISC) outlines the state of organized criminal activity in Canada. In this report, CISC says it expects to see more credit and debit card fraud in the future and that hackers are targeting online sites including online bank accounts using various methods such as key logging and malware to steal sensitive information and identities. ⁵CSIC Report on Organized Crime:
In August 2009, PandaLabs⁶ reported that Identity theft via malware was set to skyrocket and password theft resulting in identity theft from those malware infections would rise as much as 600 percent in 2009. ⁶PandaLabs Security report:

Of course the identification process goes beyond establishing identity, it involves assessing other criteria, including the person's civil identity credentials, their role or whether the individual is authorized to conduct certain actions. Although establishing identity is not a new requirement, the implications of establishing identity are different in a digital world. Unique challenges exist when determining identity in an online environment as opposed to face-to-face. For example, how do you determine who is accessing an electronic health record or a host of valuable resources, such as remote instruments, e.g., telescopes or supercomputers, licensed materials such as those held by libraries or bank accounts are access online based on an individual's identity, credentials, role and authorization. The risks to individuals, governments and businesses of allowing unknown or unauthorized individual access to these resources are immense.

The catchphrase “Identity is Centre” was coined by Phil Becker of Digital ID Magazine. He went on to state, “By using digital identity (including biometric identity) as the key transaction and user identifier, a product or application can offer trusted computing and networking with heightened security, audited data manageability, and networking flexibilities” “If digital identity is treated as the network integrator and organizer it becomes crucial for distributed or federated tasks making recipient/sender ID, task compliance/collaboration, and task audit logs and audit trails relatively easy to compile”. Identity and electronic human authentication should be the key offering in any credential/authentication service because identity will be verified by a credential holder many times each day, while credentials are established once and bound to the user's identity usually at the time of identity-validation and credential-proofing.

In order for government to fulfill its critical functions, it must be able to authenticate its citizens' claims about their own identities and characteristics. As digital government becomes a reality, the need for reliable digital identifiers becomes increasingly urgent. At the same time, digital government identifiers create unique threats to privacy as current practices of using personal information break down.

Therefore there is a continued need to improve systems and methods related to security of the Internet, electronic data, personal identity and e-commerce.

### BRIEF DESCRIPTIONS OF THE DRAWINGS

FIG. 1 is a schematic diagram of a two-sided revenue business model of one embodiment of the invention.

FIG. 2 is a graph of projected revenue.

FIG. 3 is a chart of model pricing showing value proposition for the consumer.

FIG. 4 is a chart showing the three-level pricing model.

FIG. 5 is a chart of platform services.

FIG. 6 is a schematic of the FlickerCard.

FIG. 7 is a schematic of the process of binding civil identity credentials.

FIG. 8 is a view of the FlickerCode.

FIG. 9 is a schematic of federated identity of one embodiment of the invention.

FIG. 10 is a chart representing value proposition of one embodiment of the invention.

### DETAILED DESCRIPTION OF THE INVENTION

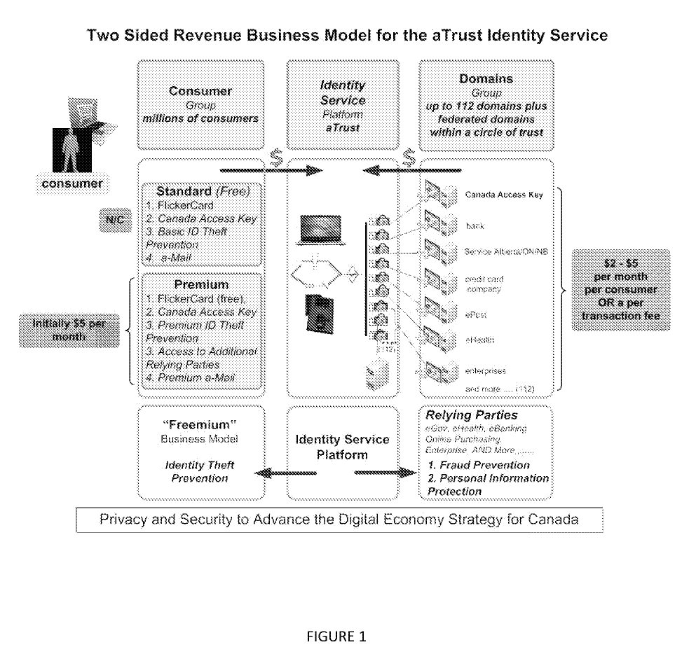

The Two Sided Revenue Business Model for identity Service Providers Refer to FIG. 1. Internet usage is growing rapidly and it can be accessed from almost anywhere by numerous means. The Internet has become a large market for companies and recently governments; some of the biggest companies today have grown by taking advantage of the efficient nature of low-cost advertising and e-commerce through the Internet. It is the fastest way to spread information to a vast number of people simultaneously. The Internet has subsequently revolutionized shopping and access to sensitive and non-sensitive information. The Internet easily allows computer users to remotely access other computers and information stores, wherever they may be across the world. They may do this with or without the use of security, authentication and encryption technologies, depending on access requirements. Easy Internet access is encouraging new ways of working from home, collaboration and sharing information in many industries. An accountant sitting at home can audit the books of a company based in another country, on a server situated in a third country that is remotely maintained by IT specialists in a fourth country. An office worker away from their desk, perhaps on the other side of the world on a business trip or a holiday, can open a remote desktop session into his normal office PC using a secure Virtual Private Network connection via the Internet. This gives the worker complete access to all of his or her normal files and data, including email and other applications, while away from the office. This concept is also referred to by some network security people as the Virtual Private Nightmare, because it extends the secure perimeter of a corporate network into its employees' homes.

Traditional business strategies are designed for “single-side” businesses operating in a one-dimensional world. In this world, decisions about products and customers and suppliers are usually made sequentially across the supply chain.

In a two sided revenue business environment the success of each side is deeply dependent upon the success of having all sides come together around a common platform, therefore strategies, tools, and methods are radically different. For our identity Service we have chosen to use a two-sided revenue business model along with a Freemium⁷ pricing strategy for one of the two groups. A two-sided business model is also referred to as a network, an economic model consisting of two distinct groups that provide each other with benefits which exhibit demand economies of scale. In our two sided revenue business model, members of each group exhibit a preference regarding the number of users in the other group and the aTrust Identity Service, the platform which brings value to both groups. ⁷Freemium is a business model that works by offering a basic product or service, or a basic downloadable digital product, for free, while charging a premium for advanced or special features. The word “freemium” is a portmanteau created by combining the two aspects of the business model: “free” and “premium”. The business model has gained popularity with Web 2.0 companies.

Users on each side of our two-sided revenue business model require very different functionality from the Identity Service platform including novel pricing strategies that are employed to attract the two groups to the platform, consumers and Service Providers. Revenue is to the left and the right in the diagram above while the platform with its operating costs is in the middle. The Identity Service platform incurs costs in serving both groups but it collects revenue from each group, although the consumer side is initially subsidized under the Freemium business model.

The two groups, consumers and Service Providers are attracted to each other—a phenomenon that economists call the network effect. The identity service's value to any given user largely depends on the number of users on the network's other side. Value in the network grows as the Identity Service matches demand from both sides. For example, Service Providers will use the Identity Service Platform for secure Consumer access to their applications because there are a critical mass of Consumers. In turn, Consumers favour the network because it offers fraud-less and identity theft prevented, secure access to multiple online applications belonging to various Service Providers on the other side of the network.

Because of the network effect, the Identity Service is expected to enjoy increasing returns to scale. Consumers will pay a premium for the high security and identity theft prevention the Identity Service provides, but only if there are multiple Service Providers with application of interest where fraud and identity theft are issues. As the number of Consumers and Service Providers grow, margins will increase along with the scale of the network. This sets network platforms such as the aTrust Identity Service Platform apart from most traditional service businesses in which business growth beyond some point usually leads to diminishing returns; acquiring new customers becomes harder as fewer people, not more, find the firm's value proposition appealing.

### Projected Revenue Profit/Loss & Number of Users

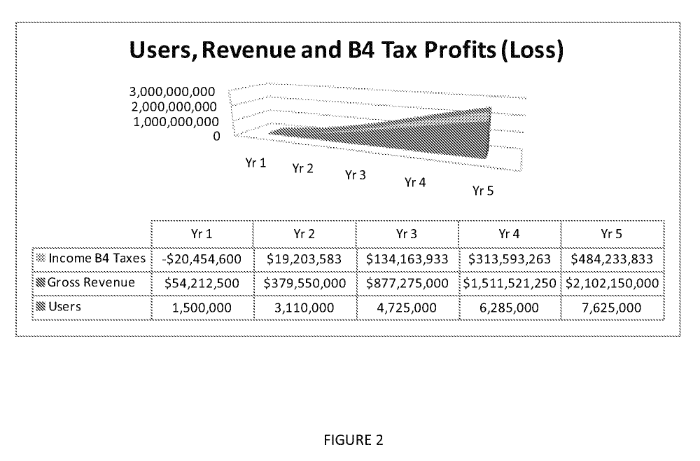

FIG. 2 shows projected revenue and income generated by users of the Identity Service. Additional financial information can be found below in the section on Financial Projections.

### Consumers

In this business model the consumer is the client, the individual who receives the offered service, a citizen or landed immigrant of Canada eligible to access federal government and other federated business services offered online. This business model uses “free” as a form of marketing to the Consumer group to put a FlickerCard in the hands of a maximum number of Consumers, projecting to convert 40%⁺ to paying customers. The Platform will initially subsidize the Consumer by offering the Consumer a no charge basic subscription to access the Canada Access Key portal or a portal of any other Service Provider that subscribes to the identity Service Platform. As the number of Service Provider's using the Identity Service Platform grow, the Identity Service can offer the consumer premium priced value added services such as access to additional Service Provider portals, advanced identity theft prevention and additional bundled services.

Bundling products and services has become almost a standard in web based product and service delivery. In our business model the costs to distribute the premium version is minimal once the standard service has been deployed. Our two sided revenue business model is basically a way of bundling where the standard (free) version is provided to consumers to create the lowest possible barrier to adoption, with the objective to gain a large customer base, build loyalty and trust, and convert some of the customers to a fee-based premium version.

### Pricing the Premium Bundle

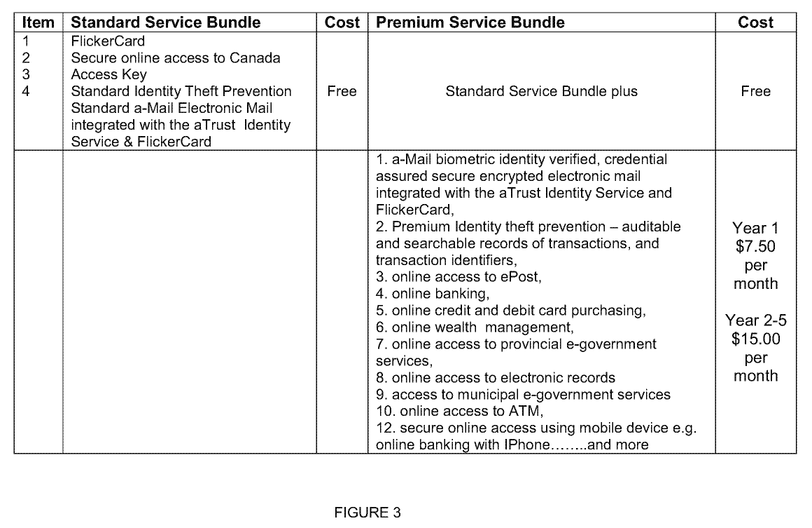

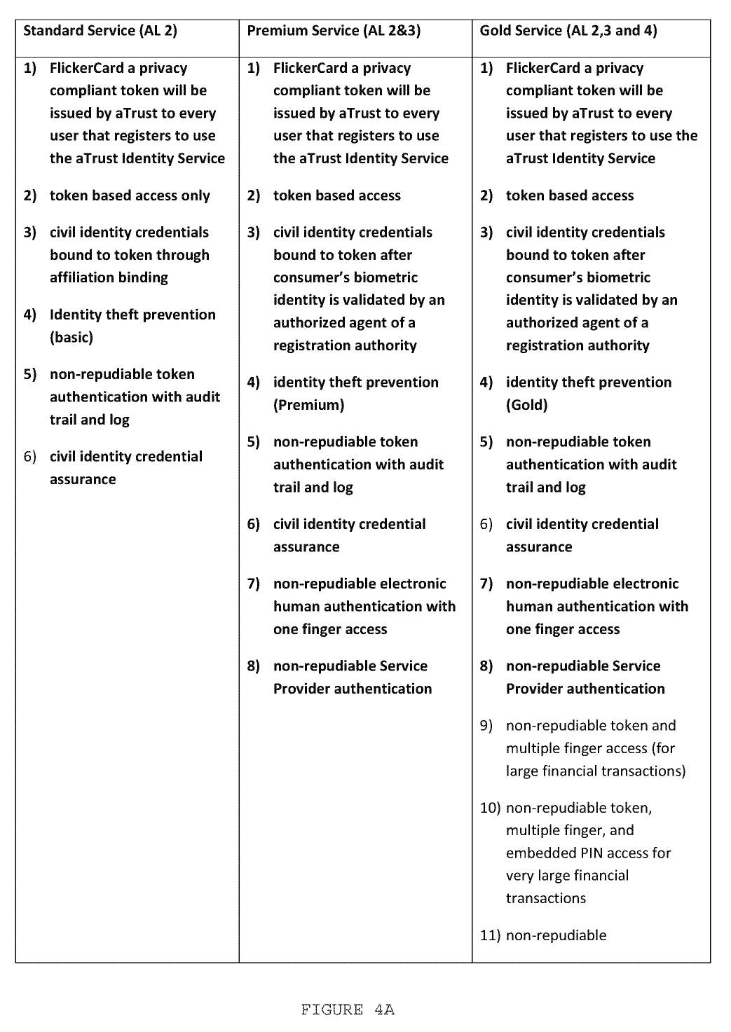

Refer to FIG. 3. The Figure shows the value proposition for the consumer. Value is subjective and people attach different values to different value propositions so the challenge is to properly segment users and features such that customers who are able and willing to pay high prices, do so. In addition to the free version, we have priced the premium bundled service so that consumers will pay a premium price for the high-end version which is expected to be highly valued by the Consumers who choose to use it.

### Service Providers

Two sided business models typically involve complex business arrangements and practices that seem unusual when considered from the perspective of traditional one sided businesses. This business model addresses markets in which the volume of transactions between end users depends upon the structure of the fees charged by the platform (aTrust Identity Service), which manages physical identity authentication and a privacy compliant database of user's civil identity credentials to develop a relationship between the Consumer and the Service Providers. This scalable identity/credential system can accommodate millions of individual identities and credentials in a privacy compliant manner and allow users to “choose” and “manage” their own physical (biometric) and civil identity credentials at high levels of government mandated identity assurance. Revenue will to be generated by providing physical identity and civil identity assurance to online service providers such as governments, organizations and enterprises, which are expected to pay a subscription or transaction fee for identification and civil identity credential assurance services at assurance levels 1-4. Further revenue is expected to be generated by consumers subscribing to the bundled Premium Services for Consumers.

The aTrust Identity Service is also of interest to organizations that offer online financial services or provide access to personal and sensitive financial and sensitive information. These organizations normally deal with a large number of consumers and are interested in eliminating fraud including friendly fraud⁸ and identity theft. ⁸Friendly fraud also known as friendly fraud chargeback is a credit card industry term used to describe a consumer who makes an Internet purchase with his/her own credit card and then issues a chargeback through his/her card provider after receiving the goods or services.

Assurance Delivery and Pricing for Service Providers with Large User Base

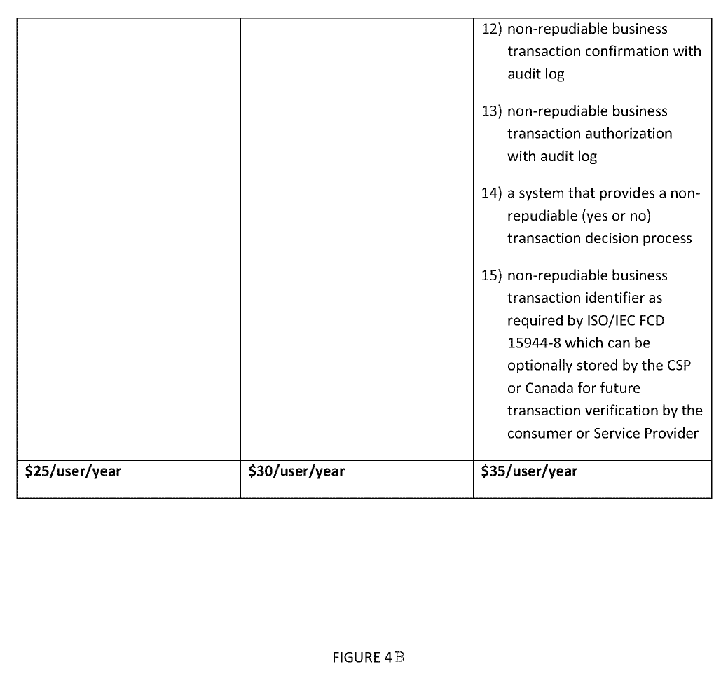

Refer to FIG. 4. There are a number of different strategies for pricing the Platform Service for Service Providers. The three level pricing model tabled below consists of a basic service (at Assurance Level 2), a premium service (at Assurance Level 3), and a gold service (at Assurance at Level 2, 3 and 4) each with its own benefits package.4
1) Fixed monthly/yearly pricing,
2) Transaction based pricing,
3) Other—to be discussed
   The aTrust Identity Platform Services

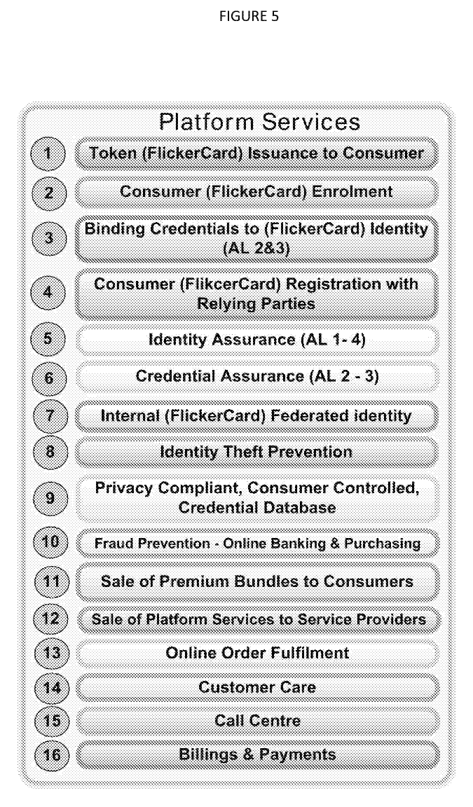

Referring to FIG. 5, the two-sided revenue platform creates value and therefore secures profit opportunities. In the aTrust Identity Service business model there are two distinct groups of customers. As stated previously, members of one group need members of the other group to realize value. Technology and therefore transactions costs impede these groups from getting together. The aTrust Platform helps members of these two groups to come together and capture the externalities between them.

Our belief is that deploying a total two-sided Platform is of strategic importance for an Identity Service Provider. The seamless integration of consumers that currently use Government of Canada's epass is only one step for the platform operator to add value to the two groups of customers (Consumers and Service Providers). The table to the left lists some of the platform service, business process and value-added services that extract value from the Consumer controlled, privacy compliant, data assets of the Identity Service. These services address a wide range of cost, efficiency and solve remote access problems for a broad range of government and commercial customers.

1. Token (FlickerCard) Issuance:

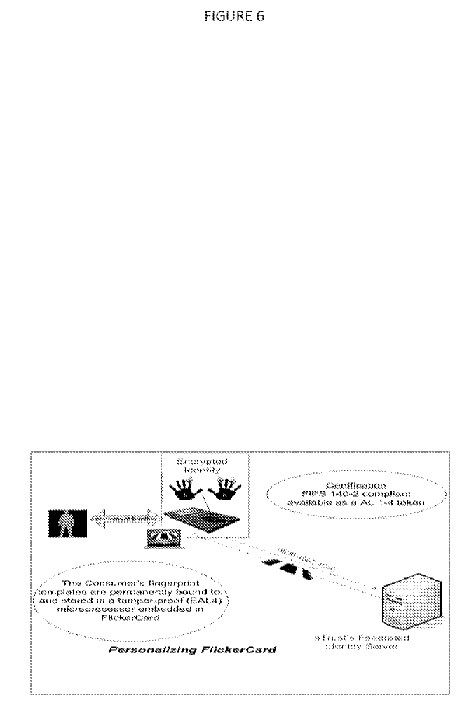

Refer to FIG. 6. FlickerCards will be available to Consumers through retails outlets, e.g. postal outlets, and possibly provincial driver's license outlets.

2. Personalizing FlickerCard:

Personalizing FlickerCard is easy and a Consumer can embed finger templates and a PIN in his/her FlickerCard offline, without connecting to a peripheral device or a PC. The finger templates are encrypted and stored in FlickerCard's internal memory and are always in the possession of the Consumer. This feature eliminates the need for a centralized biometric database and since a FlickerCard includes on-board finger template matching technology, the Consumer's finger templates are not transmitted to and from an authentication or template storage server.

### Registering FlickerCard—

After a Consumer has personalized his/her FlickerCard, it is necessary for the Consumer to open a customer account on the Platform web site and enter basic customer information. This step includes uploading a recent photograph or a live digital facial image, which is required for warranty, replacement, and re-issuance purposes. The registration process allows the Consumer to activate their FlickerCard enabling them to verify their identity online. The Consumer can now be uniquely identified through the online managed registration and authentication process. However an identity claim can be verified with documentary evidence through authoritative source when the Consumer's FlickerCard serial number is bound with the Consumers civil identity credentials as described in item 3 below.

### Maintenance:

aTrust will maintain issued token's over their lifecycle, which might include revocation, reissuance/replacement, re-enrolment, expiration, suspension, or re-instatement.

3. Binding Civil Identity Credentials to FlickerCard's Serial Number:

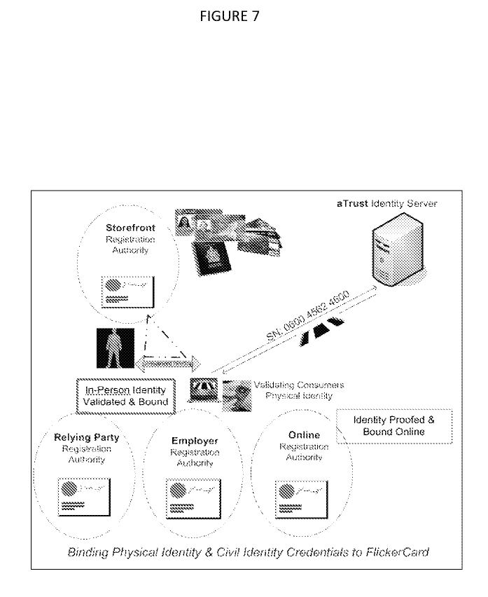

Refer to FIG. 7. FlickerCard is fully mobile and works from any browser from anywhere in the world without the need for peripheral readers. It is therefore easy for the Consumer to take his/her FlickerCard to a registration authority (RA) where the Consumer's biometric identity is validated by an authorized agent of the registration authority. During step 1 the Consumer conducts a Level 3 biometric authentication using his/her FlickerCard to verify his/her physical identity as being the one the Consumer registered on the aTrust web site. During step 2 the Consumer's civil identity credentials are viewed and recorded along with the FlickerCard serial number by the authorized agent. The civil identity credentials are now bound to the Consumer's physical (biometric) identity stored in the Consumer's FlickerCard. The registration process will require the person to present proof of real-world identity (such as a birth certificate and passport or driver's license) and/or proof of other identity attributes required by Canada Access Key for a level 3 credential assurance. The Registration Authority agent binds (associates) civil identity credentials belonging to the Consumer (FlickerCard user) to its serial number. This binding of the Consumer's validated identity assures that all future claims based on the mapped credentials are originating from the Consumer with the asserted identity. Through this permanent binding of the physical identity of a Consumer to his/her FlickerCard, a Service Provider is assured that an assumption about the presented credential is valid. As shown in the diagram above the Consumer can be accredited and civil identity credentials bound by additional accreditors and Service Providers such as the Consumer's employer, a Passport Office, and a Provincial/State driver's license office, a bank and an accredited educational institution.

By establishing the registered identity of the FlickerCard holder, the degree or level of certainty that the FlickerCard holder is in fact who he or she claims to be is heightened. The FlickerCard holder's physical identity based on the Service Provider's requirements is established at Assurance Levels 2 & 3. Similarly a Consumer can bind his/her civil identity credentials to his/her FlickerCard serial number with multiple certified and non-certified registration authorities. Multiple identity bindings with multiple registration authorities provide a stronger identity, resulting in higher credential assurance levels.

4. Consumer (FlickerCard) Registration with Service Providers:

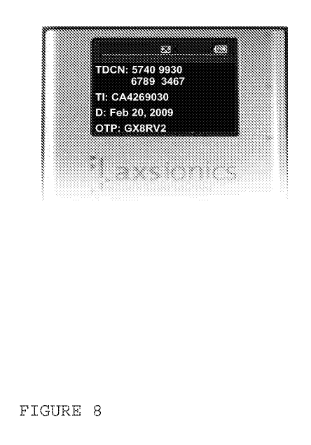

Refer to FIG. 8. Once a Consumer has completed the identity binding process, he/she is able to register with a Service Provider of his/her choice to gain assured online access at AL 1-4 to the Service Provider's online application or stored data. When registering with a RP the factory embedded digital certificate stored in one of FlickerCard's secure communication channels is replaced via FlickerCode with a new AES256 bit asymmetric digital certificate and associated with another specific digital certificate located in the RP server leading to non-reputable FlickerCard and Service Provider authentication.

### Corporate Security Signature—

a unique aTrust security feature which involves the issuance by aTrust of a digital security certificate which digitally binds the legal corporate identity of the Identity Service Provider or the Service Provider to its legal corporate logo. This digital certificate is also associated with one of FlickerCard's 112 secure channels through an AES256 bit certificate. Whenever a Service Provider communicates with a FlickerCard, the digitally signed corporate security signature in the form of its corporate logo is displayed on FlickerCard's secure internal screen providing the Consumer with assurance about the identity of the Service Provider, making impersonation (phishing, pharming and man-in-the-middle attacks) impossible. An organization's digitally signed and encrypted secure corporate signature, bound upon commissioning by aTrust, is considered as the “biometric” identity of the organization. Digitally signed, securely displayed, corporate logos protect all parties involved in a transaction, including a Service Provider as well as the Consumers from Identity theft and abuse by hackers, impostors and phishers.

5. Identity Assurance (Assurance Levels 1-4):

Research with users has shown that a majority of people do not want to use passwords and prefer to use virtually anything that allows them to access online applications or to access a PC without the necessity of remembering passwords. The aTrust Identity Service permits Consumers seeking access to use a higher level of authentication (token only or biometric) instead of passwords for AL 2 access as may be required by RPs for access to certain applications.

The aTrust Identity Service will:
a. Ensure that a FlickerCard is properly authenticated at AL 2 (includes non-reputable FlickerCard and Service Provider authentication);
b. Ensure that all Consumers seeking access at AL 3 are biometrically authenticated (including non-reputable Consumer, FlickerCard and Service Provider authentication);
c. Optional—Level 4 authentication is optionally available to Service Providers. For example, a bank customer wishes to transfer $100,000 and the bank requires AL 4 assurance for this transaction. Also optionally available to the bank and other Service Providers is non-reputable transaction confirmation, non-reputable transaction authorization, and a non-reputable transaction identifier which can be recorded and stored by the Identity Service for possible use later in case of a dispute between the transacting parties.

6. Credential Assurance (AL 2&3):

A credential is an object that authoritatively binds an identity (and optionally, additional attributes) to a token (FlickerCard) which is held and controlled by a Consumer. However the legal complexity and costs associated with general purpose Internet identities or credentials are a challenge. Who will issue and warrant an identity and credential, vouching for Consumer in all access contexts? The legal complexities of, and risk mitigation strategies required by legal departments of Service Providers will want to carefully examine risks and liabilities of cross authentication as required in a standard federated environment. Identity/Credential Providers today providing assured assess within a standard federated environment issue credentials to their customers for well defined applications like Internet banking and eGov access and do not contemplate the use of those credentials elsewhere. For starters, lawyers will want to know how liability is to be managed if an error made by one Identity/Credential Provider inflicts damages to untold Service Providers.

To gain access to certain online applications an “in person” credential verification and identity binding are required by Service Providers. However, the emphasis on which civil identity credentials are required for Levels 2 and Level 3 access is expected to vary with the Service Provider involved. For instance, the Canada Revenue Agency might be concerned with matching the SIN number with the identity of a Consumer and possibly the prevention of phishing, pharming and identity theft, which affects Consumers during tax filing season. A bank, more interested in a Consumer's financial accountability might focus on financial credibility offered by credit reporting agencies to go along with “in person” verification of the Consumer's civil identity credentials by an authorized bank agent.

Similarly, where the Identity/Credential Provider plays a role the assurance factors that a Service Provider might need vetted will vary from RP to RP. Accordingly, seeking a focused credential solution such as that currently provided by a bank is fraught with complexity. And trying to extend a limited point solution developed for one set of RPs to work with a wide range of other RPs is likely not achievable.

The aTrust Credential Assurance procedure plans to identify a Consumer's “ipseity”, the Consumer's fundamental inescapable identity that is unique and does not change over time. aTrust will achieve this task by binding the Consumer's FlickerCard serial number, which was previously bound “in person” with the Consumer's biometric identity and civil identity credentials, with the Consumer's ipseity, which in this case is an identifier string. The Consumer's ipseity string and the Consumer's photo captured online using aTrust's unique facial image capture system will allow for straightforward token replacement due to a warranty problem or the loss or damage to a FlickerCard.

7. FlickerCard's Internal Federated Identity: Background—

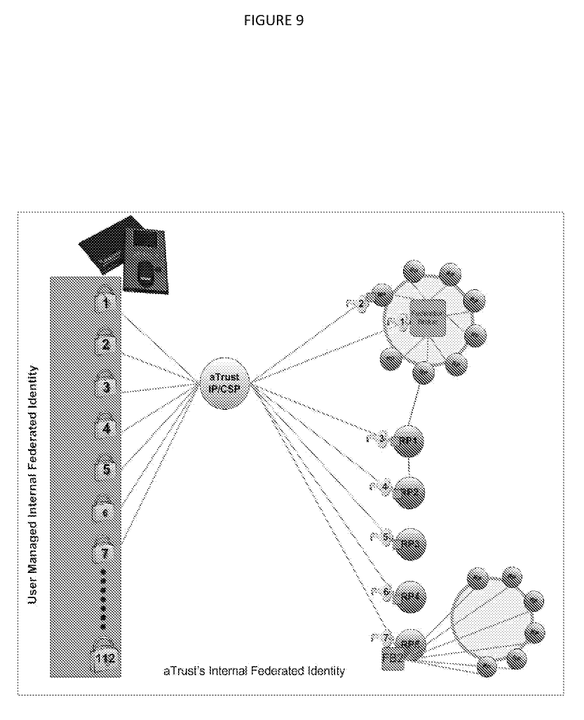

Refer to FIG. 9. Traditional Identity federation involves carefully crafted contractual silos, in which businesses know their customers for the purposes of accessing specific applications and break them open so that business strangers with no prior relationship can transact with each other. The cost of having lawyers even come to grips with this situation, let alone negotiate around the novel pro form a contracts, is huge and difficult to constrain. The legal complexity and costs associated with general purpose Internet identities or credentials are a challenge. For example, who will issue a warrant, an identity, or a credential, vouching for the Consumer who initially secures access to a Service Provider located within the circle of trust of the Federation Broker. Using Internet Single-Sign-On the Consumer is able to cross-authenticate to RP1 as indicated by the red line, or from RP1 to RP2 shown in the diagram to the left. However, legal complexities and risk mitigation strategies required by legal departments of Service Providers will want to carefully examine risks and liabilities of cross-authentication and are a costly impairment in this type of federated identity model. The classic Identity/Credential Providers today issue credentials to their customers for well defined applications, like Internet banking, and do not contemplate the use of those credentials elsewhere. For starters lawyers will want to know how liability is to be managed if an error made by one Identity/Credential or Service Provider can do damage to untold Service Providers.

aTrust's Internal Federated Identity—

The on-hand solution from aTrust involves internal federated identity and credential management systems embedded within the Identity Service software and FlickerCard. Each of FlickerCard's 112 secure AES256 bit encrypted communication channels is securely associated with a Service Provider and assures a bilateral relationship between the Consumer and the Identity Provider on one side, and with subscribing Service Providers on the other side, both sides recognizable in legal terms. Upon a user registering with a Service Provider, one secure communication channel embedded in FlickerCard is allocated to the new Service Provider and is uniquely and permanently associated and controlled by the Service Provider. However, it is the Consumer that decides whether to register with a particular Service Provider and therefore it is the Consumer that decides to let the Platform automatically allocate a secure communication channel to that particular Service Provider. This shared control of communication channels allows a flexible realization of identity federation with trust established and shared between the Consumer and a Service Provider secured by a simple bilateral use agreement. Therefore a registered Consumer gaining authorized access within an internal federated circle of trust can be recognized in legal terms by all the Service Providers in the federation because the legal, technical and business arrangements are internal to the federation and simply put in place by mutual consent.

It is important to note that a in addition to solving the legal relationship problem of typical federated identity and Internet single-sign-on, only the user-side identity management can handle the proliferation of identity credentials for the Consumer. The real advantage of the aTrust internal federated identity system lies in its ability to give full management and access control to the Consumer by way of an electronic lock box while the Service Provider retains full management and control of access requirements, authorizations, and assurance levels. A single FlickerCard and the Identity Service assumes the administration of multiple identity based relations of the typical e-business user and of multiple Service Providers.

Consumer registrations and application usage are governed by a bilateral IP legal agreement between the Consumer, the Identity Service and participating Service Providers. In the diagram above titled, User Managed Federated Identity, each of the other Service Providers associated with the Consumer's FlickerCard's channels 3 to 7 have a direct legal relationship with the Consumer, which was issued credentials from the internal federation via the Identity Provider or the Service Providers own identity verification framework. Therefore Service Providers are not involved in the shared or bilateral legal issues as in the legally associated federations also shown in the above diagram clustered around the Federation Broker and FB2. The aTrust Identity Service and the Consumer's FlickerCard's secure communication channels 3 to 7 have created an internal federation allowing the user to securely gain access into any one of the legally associated Service Providers. The diagram above illustrates that the aTrust model is flexible and fluid in that internally federated identities with the consent of the user migrate to a closed-loop federation and vice-versa depending on an evolving economic and legal landscape.

### Cross-Domain Authentication—

In a traditional federated identity access system, Consumers may be allowed to conduct a cross-domain login, i.e. using a login assertion from one domain to login to another domain. Since competing authenticating systems from legacy vendors and Identity Service Providers do not have systems that contain multiple secure communicating channels and privacy compliant mobile electronic human authenticating systems they cannot authenticate a Consumer to more than one Service Provider and therefore need to cross-authenticate a federated identity access model which is considered by most lawyers a legal liability nightmare.

The aTrust Identity Service with FlickerCard allow the Consumer to login to different Service Providers using automatically assigned internal AES256 bit encrypted secure communication channels and privacy compliant electronic human authentication at Assurance Levels 1-4.

### Addressing Risk—

Consumer control, choice and permission are central to the aTrust vision. The aTrust Identity Service is built upon the presumption that attributes within a circle of trust of legally related Service Providers will be shared in the context of permissioning, i.e., upon the consent of the Consumer and in accordance with the usages expressed by the Consumer.

Across multiple legally unrelated Service Providers there will likely be many different authorization policies, access assurance levels and deployed systems. Strong privacy measures undertaken by a single enterprise become meaningless if its data-trading partners do not have compatible measures; the policies and technologies of all federation members must satisfy the requirements of the trusting party. With this view in mind aTrust as an identity Provider plans to simply established rules and standards, by publicly declaring the manner in which it operates, the rules it agrees to follow, and the liability (if any) that it will accept for incorrect identity credentials and identity assertions.

### Flexibility—

It is also possible for more than one IP/CSP to use the aTrust system and become a FlickerCard issuer.

8. Identity Theft Prevention:

The majority of stolen sensitive information about consumers comes from lost or stolen wallets containing credit and debit cards and from lost, stolen or discarded letter mail. However passwords and PIN numbers used to access online bank accounts are stolen online by phishers and hackers, more specifically by their software worms and keystroke logging malware. Although mainstream password based authentication is easy to use since most users choose the same password to access various domains where passwords can get linked from one domain to another.

### Online Access—

The aTrust Identity Service and FlickerCard provide identity theft prevention to a subscribing consumer. The advanced identity theft prevention system is a secondary resultant service of the aTrust Identity Service, and available to all premium subscribers. Since the Consumer does not need to use passwords or other hackable information for online access, the Consumer's identity cannot be hacked or stolen. Once secure access based on FlickerCard identification is set up, access is denied to the cardholder's online data or information without FlickerCard biometric identity based access. More importantly, even if a Consumer's identity is lost or stolen, online access is still protected because without FlickerCard, access to the online portals to which the Consumer has obtained authorized access will be denied.

### Online Banking and Purchasing—

Most Consumer identities stolen online involve financial transactions such as online banking and purchasing. When shopping or banking online with FlickerCard, the Consumer's identity is not used or revealed thereby preventing identity theft.

9. Privacy Compliant Consumer Controlled, Civil identity Credential Database:

The Company has developed a methodology which allows the consumer to fully control his/her basic and private information and its dissemination to Service Providers with whom the Consumer chooses to register. This methodology permits a user to ultimately decide what information will be disbursed by the Identity/Credential Provider to a Service Provider with whom the Consumer has registered. The Consumer's personal information, without details, will be stored in a privacy compliant database kept in a certified secure hosting facility. For example, the database will store information that a registered Consumer has a passport, a driver's license from a particular province and a birth certificate but the serial numbers identifying these documents will not be stored in the database.

As the Consumer registers his/her civil identity credentials, associated with the Consumer's biometric identity, with multiple authoritative parties and multiple Service Providers involved in verifying and accepting identity claims, the strength of the Consumer's civil identity credentials stored in the aTrust privacy compliant database increases. This process illustrates the exponential growth of trust relationships with the addition of each relying or authoritative party and the assurance process becomes significantly stronger.

10. Fraud Prevention—Online Banking and Purchasing:

(1) The Company has developed a strategy allowing AL 3&4 access to a bank account. An identity based electronic lock box specific for banking applications will prevent fraud in chequing, and money transfers. The Consumer will be able to use his/her FlickerCard at ATM machines preventing fraud and a-Mail, aTrust's secure identity based email product will legally permit a bank to email Consumers their monthly bank statements and exchange banking information. (2) aTrust's patent pending system that uses FlickerCard and the Identity Service to deliver to a Consumer disposable credit and debit card numbers securely preventing online purchasing fraud, friendly fraud and online vendor charge-backs. A document describing fraud prevention strategy for banking and financial applications is available upon request.

11. Sale of Standard and Premium Bundles to Consumers:

When the Consumer registers with Canada Access Key or any other Service Provider, the Consumers will be issued a FlickerCard by the Identity Service with Standard Identity Theft Prevention, and Standard a-Mail Email and the ability to register with unlimited Service Providers, at no cost to the Consumer. To obtain the Premium Identity Theft Prevention Service that includes non-reputable transaction confirmation, transaction authorization, and transaction Identifier logs and records the Consumer will need to upgrade online through the Platform Service web site.

12. Sale of Platform Services Sales to Service Providers:

The Company will use its direct sales force, consultants, and partner integrators to market the Identity/Credential Service to Service Providers to banking, eHealth, federal provincial and municipal government services, and corporations. aTrust will license its Identity Authentication Server but not its civil identity credential database to Service Providers which wish to control and provide access to their own domain(s). In this case the Service Provider would use its own civil identity credential database and potentially arrange to license use of the Platform Service credential database.

13. Online Order Fulfilment:

This service includes:
1. FlickerCard subscription sales,
2. Replacement FlickerCard sales;
3. Sale of the Premium Service to Consumers,
4. Processing of order and logistic/delivery support,
5. Electronic content delivery—new electronic Consumer services and update downloads.

14. Customer Care:

Making use of online access this service will strive to better and enhance the customer experience and meet customer expectations.

15. Call Centre:

Part of customer care, the call centre a centralised office will be used for the purpose of receiving and transmitting a large volume of requests by telephone and text messages. The Call Centre will provide customers support when personalizing or using their FlickerCard for online access.

16. Billings & Payments:

The Company will provide a range of billing and payment options to customers to ensure that paying for services online is as easy and hassle free as possible.

The aTrust Value Proposition—Consumers, Platform and Service Providers

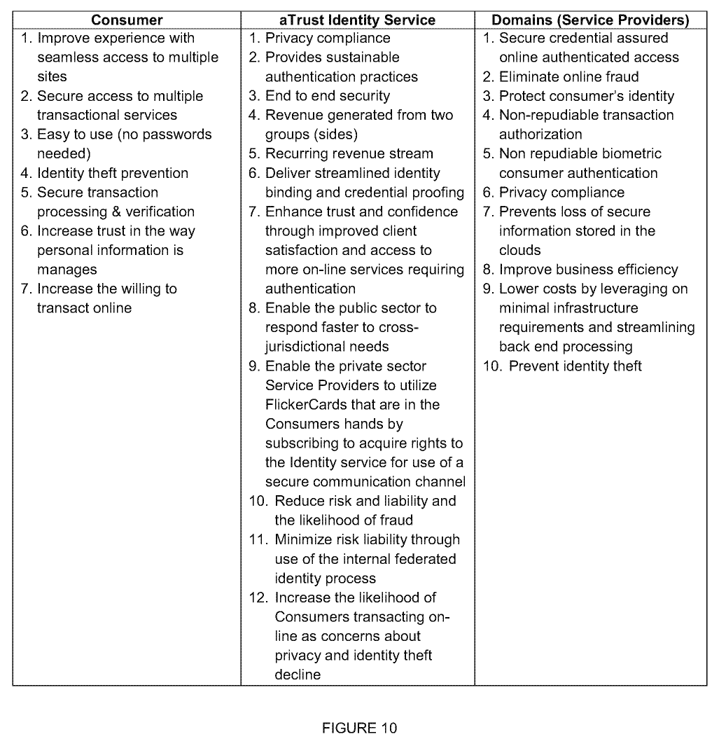

Refer to FIG. 10. A value proposition is often defined as “what the customer gets for what the customer pays” or “a bundle of products and services that are of value to the customer”. Our definition on the term value proposition in relation to business models is different. The aTrust value proposition is how value is bundled and offered to potential value recipients. The term ‘Value’ is not limited to products and services, the term ‘Value recipient’ is not limited to customers and the “Value proposition” is not always tied to the source of revenues.

What is claimed is:

1. A computer system comprising at least one server with one or more processors and memory for facilitating an electronic identity service between a group of consumers and a group of service providers, wherein the computer system is configured to: receive a consumer's request for access to a service provided by a service provider; communicate said request for access to said at least one server; automatically authenticate the physical identity of said consumer based upon a plurality of consumer's civil credentials; verify the identity of the consumer to the service provider; and, transmit the request for access to the service provider.

2. A computer-implemented method of facilitating an electronic identity service between a group of consumers and a group of service providers, comprising: at a computer system comprising at least one server with one or more processors and memory: receiving into the computer system a consumer's request for access to a service provided by a service provider; communicating the request to the at least one server; automatically authenticate the physical identity of the consumer based upon a plurality of consumer's civil credentials; verify the identity of the consumer; transmit the request for access to the service provider.

3. The method of claim 2, wherein the request for access is inputted using an electronic security token issued by a public authority.

4. The method of claim 2, wherein said electronic security token has been personalized by the consumer.

5. The method of claim 4, wherein the electronic security token is registered by the consumer with the computer system by way of a serial number, and wherein the computer system selects an assurance level for the consumer.

6. The method of claim 5, wherein the consumer loads civil identity credentials onto the security token.

7. The method of claim 6, wherein the security token is registered with the group of service providers.

8. The method of claim 7, wherein the security token is provided with a secure encrypted communication channel associated with a single service provider.

9. The method of claim 8, wherein the security token is provided with more than on secure encrypted communication channel for communication with more than one service provider.
